(19) United States
(12) Patent Application Publication
(10) Pub. No.: US 2012/0327958 A1
(43) Pub. Date: Dec. 27, 2012

(54) METHOD FOR REMOTE DEVICE PROVISIONING AND INSERTION/EXTRACTION OF OVERHEAD/EOAM DATA FOR VARIOUS PROTOCOLS

(75) Inventors: ILIAN SEVDALINOV TZVETANOV, Ottawa (CA); NIZAR RIDA, Ottawa (CA)

(73) Assignee: EXAR CORPORATION, Fremont, CA (US)

(21) Appl. No.: 13/167,596

(22) Filed: Jun. 23, 2011

(51) Int. Cl. H04J 3/04

(52) U.S. Cl. 370/536

(57) ABSTRACT

A device demultiplexes an optical signal to produce a number of client streams for client devices. The device produces overhead packets for the client devices. The overhead packets are sent using a packet interface on the device. The overhead packets are sent to the client devices with a Virtual Local Area Network Identification (VLAN ID) portion of the overhead packets identify a client device of the client devices.

### FIELD OF THE INVENTION

The present invention relates to the providing of overhead signals to client devices of an optical signal demultiplexer chip and remote device provisioning.

### BACKGROUND

An optical signal demultiplexer chip receives an optical signal and provides a number of client streams for client devices. Typically, overhead signals are sent to the client devices from dedicated pin or pins of the optical signal demultiplexer chip. A dedicated pin for overhead data and a dedicated pin for an overhead clock is required. If there are a large number of client streams and client devices, this requires a large number of dedicated overhead pins on the optical signal demultiplexer chip. Each such dedicated pin requires I/O logic and thus adds to the power consumption of the optical signal demultiplexer chip. Further, overhead is typically sent according to proprietary protocols that can be different for each client device. This can require Field-Programmable Gate Array (FPGA) logic at the client device and/or at the optical signal demultiplexer chip to handle the overhead signals. It can also require a relatively powerful external microprocessor at the client device to handle the overhead processing.

### SUMMARY

Embodiments of the present invention use a packet interface, such as an Ethernet Interface, to send overhead packets to packet interfaces on client devices. This allows an optical signal demultiplexer chip to have a small number of dedicated pins for the overhead signals. The packet interface at the client devices can also be used to send overhead data from the client devices to the packet interface on the chip to when the chip acts as a multiplexer.

The overhead packets can be sent from the chip to all of the client devices. The client devices then can examine the overhead packets to see which are for a client stream on that client device.

A Virtual Local Area Network Identification (VLAN ID) portion of the overhead packet can be used to identify the client device and client stream for the overhead packet.

In addition to overhead, additional packets such as Ethernet Operations, Administration, and Maintenance (EOAM) packets and provisioning packets can be sent using the packet interface.

### BRIEF DESCRIPTION OF THE DRAWINGS

FIG. 1 shows a prior art system with dedicated pins to send overhead for client devices.

FIG. 2A shows an embodiment of a demultiplexer chip of the present invention with a packet interface used to send overhead packets to client devices.

FIG. 2B shows an embodiment of a multiplexer/demultiplexer chip of the present invention with a packet interface used to send and receive overhead packets to and from client devices.

FIG. 3 shows an exemplary scheduling algorithm of one embodiment.

FIG. 4 shows an exemplary overhead packet of one embodiment with the VLAN ID identifying the client.

### DETAILED DESCRIPTION

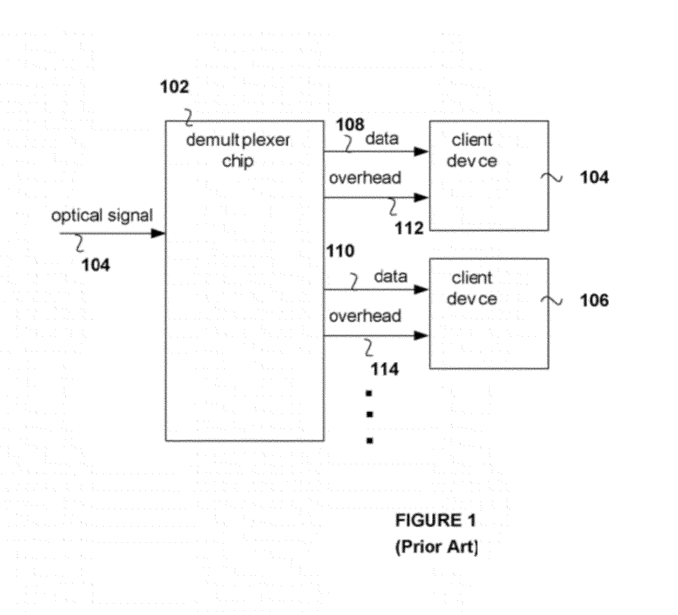

FIG. 1 shows a demultiplexer chip 102 receiving an optical signal on line 104. The data streams for the client devices 104 and 106 are sent on lines 108 and 110. Each client device also has dedicated lines 112 and 114 and corresponding pins on the demultiplexer chip 102 for the overhead.

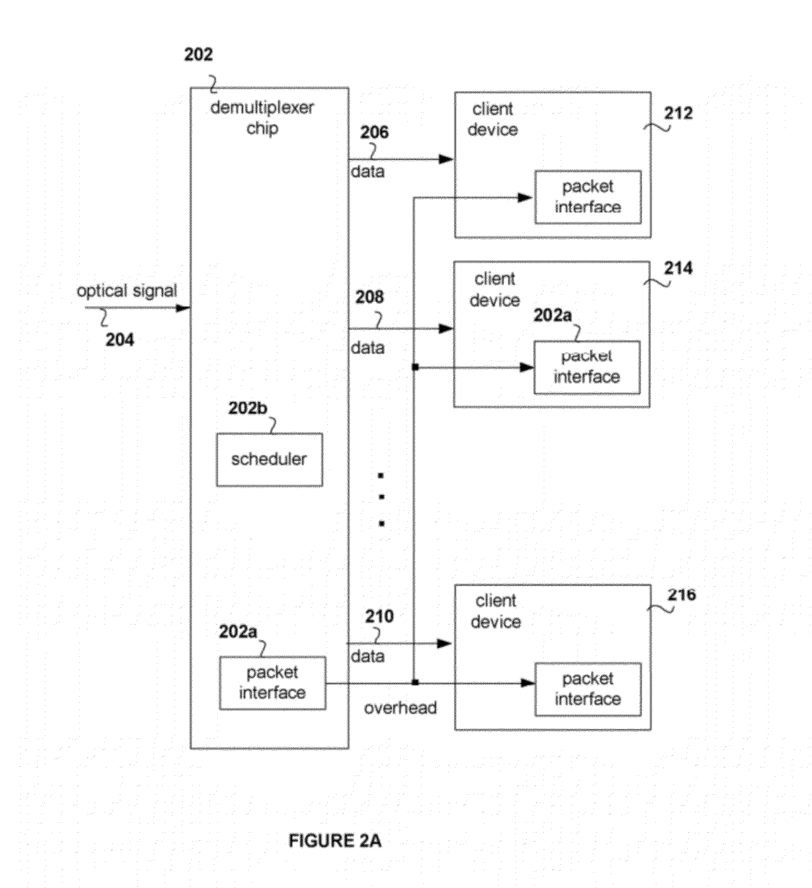

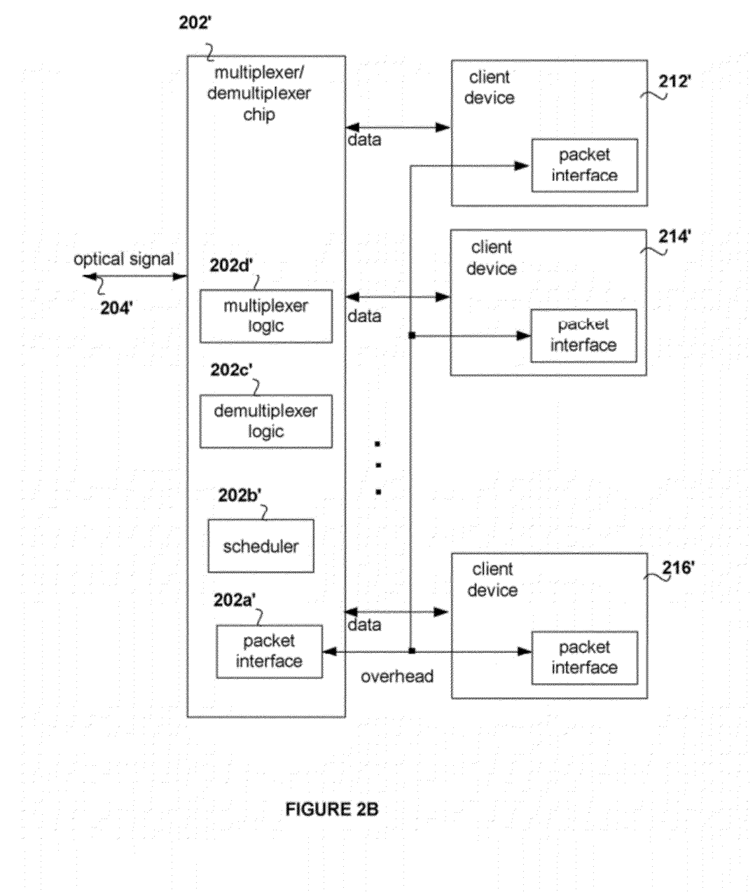

FIG. 2A shows an exemplary device 202 of one embodiment of the present invention. A device 202 is adapted to receive an optical signal on line 204. The optical signal can be an Optical Transport Network (OTN), Sonet or other multiplexed signal.

The device 202 demultiplexes the optical signal on line 204 to produce a number of client streams on lines 206, 208 and 210 for client devices 212, 214 and 216.

The device 202 produces overhead packets for the client devices 212, 214 and 216. The overhead packets being sent to the client devices 212, 214 and 216 with a virtual local area network identification (VLAN ID) portion of the overhead packets identifying a client device of the client devices 212, 214 and 216.

The packet interface 202a can be an Ethernet interface, such as a gigabit Ethernet interface. The client devices 212, 214 and 216 can also include a packet interface, such as an Ethernet interface, to receive and process the overhead packets.

A shared bus can be used to send the overhead packets. In one embodiment, since the overhead packets are valid Ethernet packets, the overhead packets can be sent through routers and other network elements before reaching the client device. Each of the client devices 212, 214 and 216 receive all of the overhead packets.

A scheduler 202b on the device 202 can select an overhead packet to be sent based on priority. The scheduler 202b can use a weighted round-robin algorithm or programmable fixed priority.

Each of the client devices 212, 214 and 216 can check the VLAN ID of all of the overhead packets. A client device, such as client device 212, of the client devices processes any of the overhead packets that have a VLAN ID that correspond to that client device, such as the client device 212.

The VLAN ID can also include a portion identifying a client stream at the identified client device.

The device 202 can be a chip including pins for accessing the packet interface 202. The chip 202 need not have other overhead pins corresponding to the client devices 212, 214 and 216.

A payload of the overhead packets can include a type field that is used to indicate flag, control, status or synchronization.

Additional packets can be used to send Ethernet Operations, Administration, and Maintenance (EOAM) data. The additional packets can be sent using the packet interface 202a on the device 202.

Further, packets can be used to send provisioning data. The further packets can be also sent using the packet interface 202a on the device 202.

The provisioning data can be used to update an internal microprocessor at the client device 212, 214 and 216.

FIG. 2B shows an embodiment of a multiplexer/demultiplexer chip 202′ of the present invention with a packet interface 202a′ used to send and receive overhead packets to and from client devices 212′, 214′, and 216′. The device 202′ is adapted to receive client streams from the client devices 212′, 214′, and 216′ and produce a multiplexed optical signal on line 204′ using multiplexer logic 202d′. The device 202′ can also use the demultiplexing logic 202c′ to demultiplex the optical stream received on line 204′.

The scheduler 202b′ need only service overhead bytes on the demultiplexer side of the chip. On multiplexing side of the chip, the packets can be sent as soon as they are received from the clients. The VLAN ID and packet structure can be the same for both sides of the chip (demultiplexer and multiplexer).

In a device that supports a large number of clients and trunks, the process overhead insertion and extraction can be very challenging when using an external microprocessor interface or a dedicated interface with few pins. It is very important for complex devices to have the overhead processing done in a timely fashion to avoid the situation where an overhead opportunity for insertion and extraction gets missed. To accomplish that and to be able to support the simultaneous processing of multiple overhead bytes, a method that uses a packet interface, such as a gigabit Ethernet interface, that maps overhead data was devised. This method relaxes the external microprocessor requirements and gives a flexible access to the overhead bytes from any node anywhere in the network.

For remote device provisioning, using this interface eliminates the need for an external microprocessor thus contributing to lowering the costs for Bill of Material (BOM) and the on-going maintenance costs. This approach will also allow the device to be fully accessible from any node anywhere in the network.

In asynchronous networks, network elements operate on independent local clocks and each of the overhead bytes and Ethernet, Operations, Administration and Management (EOAM) packets will use a different clock domain. A gigabit or high-speed serial interface for all different overhead bytes and EOAM packets, allows for a reduction of the number of pins on device boundaries for having serial access for overhead bytes insertion/extraction. A smaller number of pins produce a cost reduction by allowing for a smaller package.

Using a 6-pin serial interface per client with so many clients, will produce a lot of pins, which is unscalable. Having so many clock domains make the physical implementation unmanageable. By using an external gigabit or high-speed serial interface, this architecture is constructed to manage all these clock domains as a single clock domain.

A method for remote device provisioning and the insertion/extraction of overhead/EOAM data provides a gigabit interface that can support multiple clients like:

OTN (OTU, ODU & OPU)

SONET/SDH

MAC EOAM

Internal microprocessor bus for device provisioning

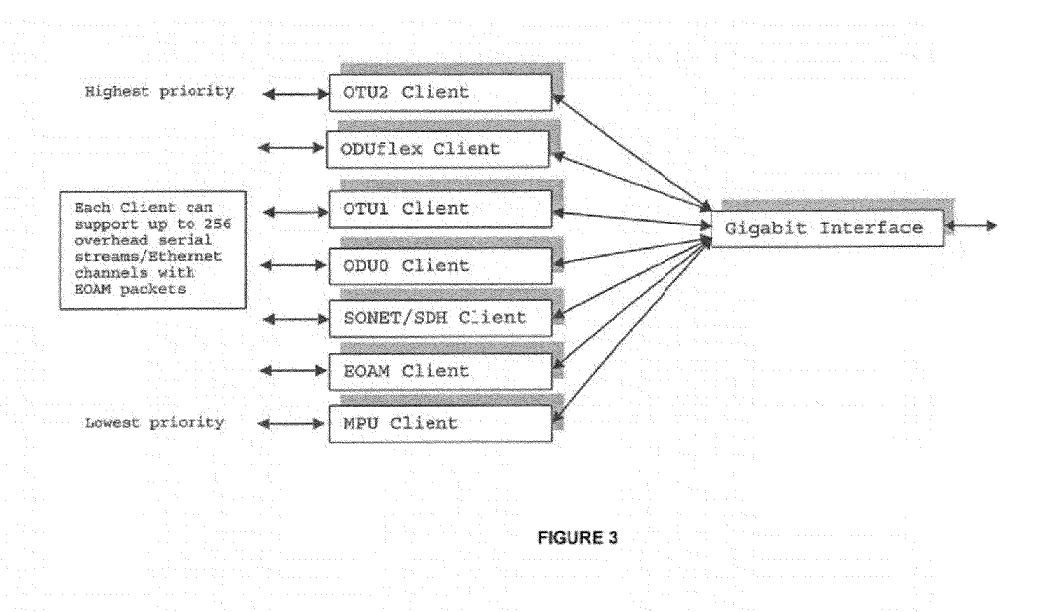

Each client has an overhead interface, where the overhead bytes for any of these clients can be selected for insertion and extraction. In order to allow clients with more sensitive timing requirements to be processed for extraction ahead of less timing sensitive client, a dynamic priority scheduling algorithm is employed. In this algorithm, the client with the most timing sensitive requirement (OTU2 client) is assigned the highest priority while the client with the least timing sensitive requirement is assigned the lowest priority. As shown in FIG. 3, clients form different types are supported with this method.

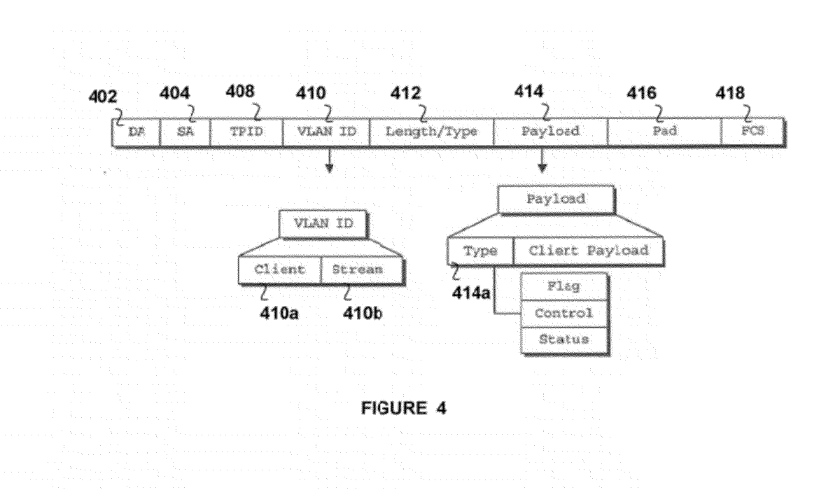

FIG. 4 shows an exemplary overhead/EOAM and provisioning packet structure of one embodiment.

Up to 16 clients plus one internal microprocessor client with up to 256 overhead serial links can be serviced with one gigabit Ethernet interface. Inserted and extracted packets for overhead bytes and EOAM frames are formatted using the following standard packet format. Multiple clients from the same type, except a microprocessor client are supported with this method.

Field DA 404 is the destination address used for device selection and EOAM frames.

Field SA 406 is the source address.

TPID is Type Payload ID which, in one embodiment, is always set to 0x8100.

VLAN ID 410 is used to uniquely identify the client. In embodiments of the present invention, the VLAN ID 410 includes a client field 410a and a stream field 410b.

In one embodiment, client field 410a is a 4-bit field is used for client selection. In this embodiment, up to 16 different clients can be supported with one of these clients used for remote provisioning.

Stream field 410b is a 8-bit field and is used for overhead stream selection from the particular client. Up to 256 overhead streams can be supported per client. When the internal microprocessor access client is selected, up to 256 different slaves can be accessed for remote provisioning.

Length/Type field 412 identifies the length of the payload.

Payload field 414 contains the inserted/extracted overhead bytes or EOAM payload data. Up to 256 bytes payload size is supported with the proposed architecture in order to meet OTU2 timing requirements for overhead data. FIG. 4 shows a payload field 414 with a dedicated type field 414a.

Type field 414a can be one byte field and is used to indicate the payload type for the overhead data. This field is used for SONET/OTN overhead packets and remote provisioning.

In one embodiment, there are three payload types:
Flag—value 0x00 used to indicate that the packet is good and does not have errors.
Control
   Value 0x55 is used and it indicates a special synchronization (sync) packet. A sync packet is used to synchronize the timing info for the external device to the timing of the client overhead interface. In order for the external device to start inserting an overhead packet, the external device first needs to synchronize with the client's start of frame. This is accomplished by having each client transmit its own control overhead packet every eight frames. When the external device receives the control packet, it will start sending a data packet to that client every frame continuously.
   Value 0xFF is used and it indicates an internal microprocessor write.
   Value 0xF0 is used and it indicates an internal microprocessor read.
Status—it indicates a client alarm condition such as
   Loss of Signal Condition (LOS) with a value of 0x01.
   Loss of Frame Condition (LOF) with a value of 0x02.
   Alarm Indication Signal (AIS) with a value of 0x03.

Client Payload Field is used for carrying overhead and internal microprocessor data.

Pad field 416 is used for additional padding in order to meet the minimum Ethernet packet size requirements from the network equipment.

FCS field 418 is optional and is used to verify packets are free of errors.

Overhead and EOAM packets are extracted every frame. A dynamic priority scheduler with a weighted round robin algorithm is used in order to allow time sensitive overhead interfaces like OTU2 timely extraction over less time sensitive interfaces like EOAM. Fixed and adaptive priority is also supported.

When an Overhead or EOAM packet is inserted, the gigabit interface receives the packet and will broadcast it to all clients. Each client picks up the packet and compares the packet's VLAN ID. If the VLAN IDs match, then the packet is identified and is passed for further processing by that client.

Assuming a minimum Ethernet payload size of 64 bytes the payload size for an OTN Overhead packet is 65 bytes long with no padding required. In the case of SONET/SDH Overhead packets, the payload size is 55 bytes long and is padded with 9-bytes of zero data in order to meet the minimum payload size requirement of 64 bytes.

Supported EOAM packets are with any payload size from 20 to 256 bytes. Internal microprocessor remote provisioning packet size is 81 bytes.

The foregoing description of preferred embodiments of the present invention has been provided for the purposes of illustration and description. It is not intended to be exhaustive or to limit the invention to the precise forms disclosed. Many embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

1. A device adapted to:
receive an optical signal;
demultiplex the optical signal to produce a number of client streams for client devices; and
produce overhead packets for the client devices, the overhead packets being sent using a packet interface on the device, the overhead packets being sent to the client devices with a Virtual Local Area Network Identification (VLAN ID) portion of the overhead packets identifying a client device of the client devices.

2. The device of claim 1, wherein the device is further adapted to receive an optical signal and produce client streams from the optical signal for the client devices.

3. The device of claim 2 wherein the packet interface on the device is adapted to receive overhead packets from the client devices.

4. The device of claim 1, wherein the packet interface is an Ethernet interface.

5. A system includes the device of claim 4, further including the client devices, wherein the client devices each include a packet interface to receive the overhead packets.

6. The system of claim 5, wherein a bus is used to send the overhead packets, each of the client devices receiving each of the overhead packets.

7. The system of claim 6, wherein each of the client devices checks the VLAN ID of each of the overhead packets and a client device of the client devices processes any of the overhead packets that has a VLAN ID that correspond to the client device of the client devices.

8. The device of claim 1, wherein the VLAN ID also includes a portion identifying a stream at the identified client device.

9. The device of claim 1, wherein the device is a chip including pins for accessing the packet interface, the chip not having other overhead pins corresponding to the client devices.

10. The device of claim 1, wherein a payload of the overhead packets includes a type field that is used to indicate flag, control, status or synchronization.

11. The device of claim 1, wherein additional packets are used to send Ethernet Operations, Administration, and Maintenance (EOAM) data, the additional packets being sent using the packet interface on the device.

12. The device of claim 1, wherein further packets are used to send provisioning data, the further packets being sent using the packet interface on the device.

13. The device of claim 10, wherein the provisioning data is used to update an internal microprocessor at the client device.

14. The device of claim 1, wherein a scheduler selects an overhead packet to be sent based on priority.

15. A method comprising:
receiving an optical signal;
demultiplexing the optical signal to produce a number of client streams for client devices; and
producing overhead packets for the client devices, the overhead packets being sent using a packet interface on the device, the overhead packets being sent to the client devices with a virtual local area network identification (VLAN ID) portion of the overhead packets identifying a client device of the client devices.

16. The method of claim 15, further comprising receiving an optical signal and produce client streams from the optical signal for the client devices.

17. The device of claim 16, further comprising using the packet interface on the device to receive overhead packets from the client devices.

18. The method of claim 15, wherein the packet interface is an Ethernet interface.

19. The method of claim 18, wherein the client devices each include a packet interface to receive the overhead packets.

20. The method of claim 18, wherein a bus is used to send the overhead packets, each of the client devices receiving each of the overhead packets.

21. The method of claim 15, wherein each of the client devices checks the VLAN ID of each of the overhead packets and a client device of the client devices processes any of the overhead packets that has a VLAN ID that correspond to the client device of the client devices.

22. The method of claim 15, wherein the VLAN ID also includes a portion identifying a stream at the identified client device.

23. The method of claim 15, wherein the device is a chip including pins for accessing the packet interface, the chip not having other overhead pins corresponding to the client devices.

24. The method of claim 15, wherein a payload of the overhead packets include a type field that is used to indicate flag, control, status or synchronization.

25. The method of claim 15, wherein additional packets are used to send Ethernet Operations, Administration and Maintenance (EOAM) data, the additional packets being sent using the packet interface on the device.

26. The method of claim 15, wherein further packets are used to send provisioning data, the further packets being sent using the packet interface on the device.

27. The method of claim 26, wherein the provisioning data is used to update an internal microprocessor at the client device.

28. The method of claim 15, wherein a scheduler selects an overhead packet to be sent based on priority.

29. A device comprising:
optical signal demultiplexer logic; and
a packet interface to produce overhead packets for the client devices, the overhead packets being sent to the client devices with a virtual local area network identification (VLAN ID) portion of the overhead packets identifying a client device of the client devices.

30. The device of claim 29, wherein the packet interface is an Ethernet interface.
